(19) United States
(12) Patent Application Publication
(10) Pub. No.: US 2020/0396306 A1
(43) Pub. Date: Dec. 17, 2020

(54) APPARATUSES AND METHODS FOR A DISTRIBUTED MESSAGE SERVICE IN A VIRTUALIZED COMPUTING SYSTEM

(71) Applicant: Nutanix, Inc., San Jose, CA (US)

(72) Inventors: AMOD VILAS JALTADE, SAN JOSE, CA (US); ADITYA VILAS JALTADE, SAN JOSE, CA (US); CHINMAY DINESH KAMAT, SANTA CLARA, CA (US); GOWTHAM ALLURI, SAN JOSE, CA (US); HARSHIT AGARWAL, NEWARK, CA (US); KARAN GUPTA, SAN JOSE, CA (US); MAYUR VIJAY SADAVARTE, SUNNYVALE, CA (US); MONIL DEVANG SHAH, MILPITAS, CA (US); PARTHA RAMACHANDRAN, SAN JOSE, CA (US); RAMYA BOLLA, SAN JOSE, CA (US)

(73) Assignee: Nutanix, Inc., San Jose, CA (US)

(21) Appl. No.: 16/528,006

(22) Filed: Jul. 31, 2019

Related U.S. Application Data
(60) Provisional application No. 62/860,981, filed on Jun. 13, 2019.

(51) Int. Cl. H04L 29/08; G06F 9/455; G06F 9/50

(52) U.S. Cl. CPC H04L 67/2809; G06F 2009/45579; G06F 9/5077; G06F 9/45558

(57) ABSTRACT

Examples of a distributed message service include a virtualized file system including a virtual disk configured to store messages for a message topic, and a broker logically allocated to the message topic. The broker is configured to cause a message directed to the message topic provided from a publisher to be stored at the virtual disk, and to route the message to a subscriber of the message topic that is registered with the broker. The distributed message service further includes an operating system configured to manage the virtualized file system and includes a message service configured to manage logical allocation of the broker and manage allocation of the virtual disk to the message topic.

### CROSS REFERENCE TO RELATED APPLICATION(S)

This application claims priority to provisional application No. 62/860,981 filed Jun. 13, 2019, which application is hereby incorporated by reference in its entirety for any purpose.

### BACKGROUND

Within a computing environment, components and applications may communicate with each other to send and receive data to perform respective functions in accordance with programmed instructions. Some message schemes exist to facilitate communication among the applications or components of the environment in the form brokers that manage routing of messages between a publishers and subscribers. The existing systems rely on a homogenous application programming interface (API) architecture, and are hosted as a standalone component of the computing environment; often in the form of one or more virtual machines. Because of this existing architecture, the existing message services may be difficult to scale, and difficult to adapt in environments with many different message schemes.

### BRIEF DESCRIPTION OF THE DRAWINGS

FIG. 1 is a block diagram of a computing system, in accordance with an embodiment of the present disclosure

FIG. 2 is a block diagram of a distributed computing system, in accordance with an embodiment of the present disclosure.

FIG. 3 is a block diagram of a distributed message service, in accordance with an embodiment of the present disclosure.

FIG. 4 is a block diagram of a distributed message service with a failed message service instance, in accordance with an embodiment of the present disclosure.

FIG. 5 is a system diagram of a cross-cluster message service replication system, in accordance with an embodiment of the present disclosure.

FIG. 6 is a flow diagram illustrating a method for a distributed message service, in accordance with an embodiment of the present disclosure.

FIG. 7 depicts a block diagram of components of a computing node in accordance with an embodiment of the present disclosure.

### DETAILED DESCRIPTION

Examples described herein include provision of a distributed message service and message queues as an integrated service running on a hyperconverged infrastructure. The distributed message service may instantiate brokers and logically associate instantiated brokers with message topics and partitions to manage communication between producers and consumers associated with the message topic-partition. The distributed message system may also leverage distributed, virtualized storage to store messages for a topic-partition. The distributed arrangement of the distributed message service (via message services instances) within the hyperconverged infrastructure facilitates load balancing related to the distributed message service across a cluster of computing nodes. The logical association of brokers with message topics and the use of distributed, virtualized storage facilitates relatively seamless failover to another broker on another computing node when an original broker fails, or to re-balance a processing load associated with the distributed message service across the computing node cluster. The use of the virtualized storage facilitates efficient storage scalability to meet needs of a particular message topic-partition.

The distributed message service may be integrated with core controller virtual machines hosted across computing nodes (e.g., host machines, servers, etc.) of a computing node cluster that are configured to manage operation of the cluster. Thus, execution of the distributed message service may be via respective message service instance hosted on each of the computing nodes. The distributed message service may be configured to interface with multiple messaging queue application programming interfaces (APIs), as well as translate messages across different messaging queue API architectures. The distributed message service may instantiate logical brokers and use virtual storage accessible across a cluster to manage individual message topic-partitions. A single topic-partition will be logically associated with a single broker instance to manage corresponding communication. In some examples, the messages may be stored on a raw virtual disk by carving out fixed sized regions. New messages may be appended in a region. In the case where the space in the region may be exhausted, a new region may be allocated to store the new messages. The new region may or may not be allocated from a different virtualized disk than the previous virtualized disk. The logical association of a broker and the use of virtual disks may allow another broker instance to take over the single topic-partition in the event of a failure of the original broker. The lifecycle of the brokers may be managed using containerized architecture. Each broker may register with a master message service instance of the distributed message service, including providing a list of topics of interest. The master message service instance may allocate topics and partitions to individual brokers based on load balancing considerations and changes in topics and partitions. Publishers may register with the master message service instance to receive an identifier and then may connect with the broker assigned to a particular topic-partition to publish messages. Any other master message service instance of another computing node may be able to take over in the event of failure of the original master message service instance. Messages published by a publisher client may include the identifier. Subscriptions may manage and track consumers/subscribers. When a subscriber connects to the computing node cluster, the subscriber may provide a handle. In response to receipt of the handle, the subscription may begin providing messages to the subscriber based on the state of the subscription. The subscriptions may be replicated across clusters to allow for geographic replication. The distributed message service may provide a scalable message service that allows for more efficient disaster recovery as compared with systems that using physical broker and storage allocations for each topic.

Various embodiments of the present disclosure will be explained below in detail with reference to the accompanying drawings. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

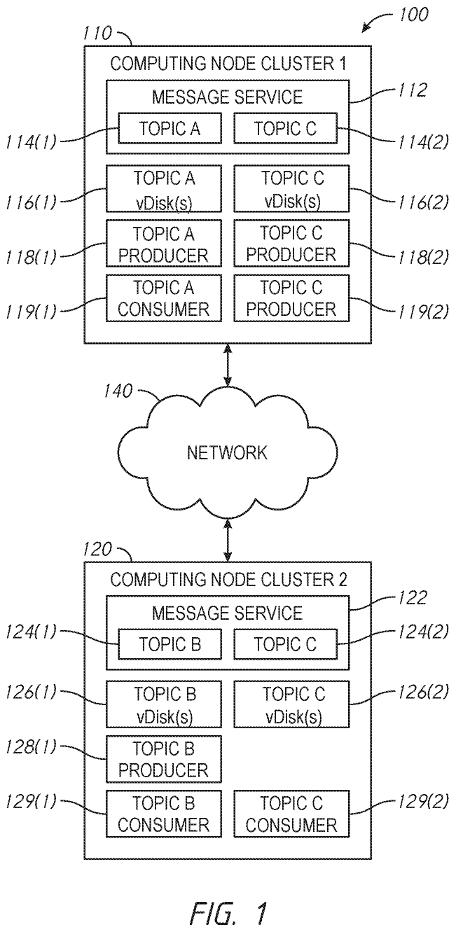

FIG. 1 is a block diagram of a computing system 100, in accordance with an embodiment of the present disclosure. The computing system 100 may include some or all of a computing node cluster 110 or a computing node cluster 120 connected together via a 140. The 140 may include any type of network capable of routing data transmissions from one network device (e.g., the computing node cluster 110 or the computing node cluster 120) to another. For example, the 140 may include a local area network (LAN), wide area network (WAN), intranet, or a combination thereof. The 140 may include a wired network, a wireless network, or a combination thereof.

The computing node duster 110 may include a distributed message service 112 that is integrated with core controller virtual machines hosted across computing nodes (e.g., host machines, servers, etc.) of the computing node cluster 110 to support an integrated message service across the computing node cluster 110 to facilitate an exchange of respective information between producers (e.g., publishers, etc.) 118(1)-(2) and consumers (e.g., subscribers, etc.) 119(1)-(2). Thus, the distributed message service 112 may include respective message service instances hosted on one or more of the computing nodes of the computing node cluster 110. The distributed message service 112 may be configured to interface with multiple messaging queue application programming interfaces (APIs), as well as translate messages across different messaging queue API architectures. The producers 118(1)-(2) may each include a virtual machine, a container, any type of computing device, an application, an input/output device, etc., or any combination thereof. The consumers 119(1)-(2) may each include a virtual machine, a container, any type of computing device, an application, an input/output device, etc., or any combination thereof.

The distributed message service 112 may instantiate and logically allocate brokers 114(1) and 114(2) to manage individual message topic-partitions. The lifecycle of the brokers 114(1) and 114(2) may be managed using containerized architecture. Each of the brokers 114(1) and 114(2) may register with a master message service instance of the distributed message service 112, including providing a list of topics of interest. The master message service instance may allocate topics and partitions to each of the individual brokers 114(1) and 114(2) based on load balancing considerations and changes in topics and partitions. The broker 114(1) may be associated with topic “A” and the broker 114(2) may be associated with topic “C”. The broker 114(1) may be configured to manage messages received from the topic “A” producer 118(1), which may include storing the received messages and providing the messages to the topic “A” consumer 119(1).Similarly, the broker 114(2) may be configured to manage messages received from the topic “C” producer 118(2), which may include storing the received messages and providing the messages to the topic “C” consumer 119(2). In some examples, the brokers 114(1)-(2) may allocate both a topic and a partition, such that one topic is broken into partitions, with each partition managed by a different broker. While the distributed message service 112 is depicted with two of the brokers 114(1) and 114(2), more or fewer brokers may be instantiated by the distributed message service 112 without departing from the scope of the disclosure. In addition, each topic may include more than a single producer and/or consumer. In some examples, either the distributed message service 112 and/or the brokers 114(1)-(2) may manage a subscription list associated with each respective topic.

The distributed message service 112 may use virtual storage (virtual disks (vDisks) 11.6(1)-(2)) accessible across the computing node cluster 110 to serve as storage for received messages for each respective message topic-partition. The brokers 114(1) and 114(2) may store messages associated with a corresponding topic at the vDisks 116(1)-(2). The vDisks 116(1)-(2) may be hosted on a virtualized distributed file server system hosted on the computing node cluster 110. Because the vDisks 116(1)-(2) are virtualized (e.g., rather than a physical storage disks), the size of each of the vDisks 116(1)-(2) can be dynamically adjusted according to data storage needs for each particular topic. In some examples, the messages may be stored on the carved out fixed sized regions in raw vDisks 1 16(1)-(2), New messages may be appended in a region. In the case of exhaustion of the space in the region, a new region may be allocated to store the new messages. The new region may or may not be allocated from a different vDisk 116 (1)-(2) than the previous vDisk. The logical association of topic-partitions to the brokers 114(1) and 114(2) and the use of the vDisks 116(1)-(2) may allow another broker instance to take over the single topic-partition in the event of a failure of the original broker.

The producers 118(1)-(2) may register with the master message service instance to receive an identifier and then may connect with the respective broker 114(1) and/or 114(2) assigned to a particular topic-partition to publish messages. Messages published by the producers 118(1)-(2) may include the respective identifier. The distributed message service 112 and/or the brokers 114(1) and 114(2) may manage and track the consumers 119(1)-(2). When one of the consumers 119(1)-(2) connects to the computing node cluster 110, the consumer may provide a handle. In response to receipt of the handle, the distributed message service 112 and/or the brokers 114(1) and 114(2) may begin providing messages to the consumer based on the state of the subscription. In some examples, the distributed message service 112 may also add the consumer to a consumer or subscriber list associated with the message topic or the message topic-partition.

The computing node cluster 120 includes a distributed message service 122 that is integrated with core controller virtual machines hosted across computing nodes (e.g., host machines, servers, etc.) of the computing node cluster 120 to support an integrated message service across the computing node cluster 120 to exchange respective information between producers (e.g., publishers, etc.) 118(1)-(2) and consumers (e.g., subscribers, etc.) 119(1)-(2). Operation of components of the computing node cluster 120 (e.g., the distributed message service 122, brokers 124(1)-(2), vDisks 126(1)-(2), producer 128(1), and/or consumers 129(1)-(2) may be similar to operation of similar components of the computing node cluster 110. Accordingly, a detailed description of the operation of these particular components will not be repeated in the interest of brevity. The producers 1128(042) may each include a virtual machine, a container, any type of computing device, an application, an input/output device, etc., or any combination thereof. The consumers 129(1)-(2) may each include a virtual machine, a container, any type of computing device, an application, an input/output device, etc., or any combination thereof.

The subscriptions may be replicated across clusters to allow for geographic replication.

For example, a subscription associated with topic “C” on the computing node cluster 110 (e.g., located in a first geographic location) may be replicated on the computing node cluster 120 (e.g., located in a second geographic location). That is, the corresponding distributed message service 122 and/or the broker 124(2) of the computing node cluster 120 may register as a consumer or subscriber of topic “C” with the distributed message service 112 and/or the broker 114(2), and in response, the distributed message service 112 and/or the broker 114(2) may share message information received from the producer 118(2) with the corresponding distributed message service 122 and/or the broker 124(2) as a consumer. In addition, the corresponding distributed message service 122 and/or the broker 124(2) of the computing node cluster 120 may register the distributed message service 112 and/or the broker 114(2) as a producer for topic “C”, and in response to receiving messages from the distributed message service 112 and/or the broker 114(2), may store the messages in the vDisk 126(2). Thus, the vDisk 116(2) hosted on the computing node cluster 110 may be replicated on the computing node cluster 120 as the vDisk 126(2).

In operation, the distributed message service 112 may be configured to instantiate logical brokers 114(1) and 114(2) and use the vDisks 116(1)-(2)) accessible across the computing node cluster 110 to facilitate communication of messages from the respective producers 118(1)-(2) to the respective consumers 119(1)-(2) for each topic-partition. Similarly, the distributed message service 122 may be configured to instantiate brokers 124(1) and 124(2) having a logical association with a particular topic-partition and may use the vDisks 126(1)-(2) accessible across the computing node cluster 120 to facilitate communication of messages from the respective producer 128(1) to the respective consumers 129(1)-(2) for each topic-partition. The lifecycle of the brokers 114(1)-(2) and 124(1)-(2) may be managed using containerized architecture. Each of the brokers 114(1)-(2) and 124(1)-(2) may register with a master message service instance of the distributed message service 112 or the distributed message service 122, respectively, including providing a list of topics of interest. The master message service instance may allocate topics and partitions to each of the individual brokers 114(1)-(2) and 124(1)-(2) based on load balancing considerations and changes in topics and partitions.

The broker 114(1) and the vDisk 116(1) may each be logically associated with topic “A”, the brokers 114(2) and 124(2) and the vDisks 116(2) and 126(2) may each be logically associated with topic “C”, and the broker 124(1) and the vDisk 126(1) may each be logically associated with topic “B”. Thus, the broker 114(1) may be configured to manage messages received from the topic “A” producer 118(1), which may include storing the received messages in the vDisk 116(1) and providing the messages to the topic “A” consumer 119(1).Similarly, the broker 114(2) may be configured to manage messages received from the topic “C” producer 118(2), which may include storing the received messages in the vDisk 116(2) and providing the messages to the topic “C” consumer 119(2). In some examples, the distributed message service 112 may also add the consumers 119(1)-(2) and 129(1)-(2) to a respective consumer or subscriber list associated with the respective message topic or the message topic-partition.

The broker 124(1) may be configured to manage messages received from the topic “B” producer 128(1), which may include storing the received messages in the vDisk 126(1) and providing the messages to the topic “B” consumer 129(1). Because the broker 124(2) is associated with replication of the topic “C” hosted on the computing node cluster 110, the broker 124(2) may be configured to manage messages received from the topic “C” broker 114(2), which may include storing the received messages in the vDisk. 126(2) and providing the messages to the topic “C” consumer 129(2). In some examples, brokers 114(1)-(2) and 124(1)-(2) may allocated both a topic and a partition, such that one topic is broken into partitions, with each partition managed by a different broker.

The brokers 114(1)-(2) and 124(1)-(2) may be configured to store received messages respective messages in the respective vDisks 116(1)-(2) and 126(1)-(2). The messages may be stored on a raw vDisk of the respective vDisks 116(1)-(2) and 126(1)-(2), by carving out fixed sized regions, Thus, when the topic “A” producer 118(1) sends a message, the topic “A” broker 114(1) appends the message to the region on the topic “A” vDisk 116(1). If the space in the region on the topic “A” vDisk 116(1) is exhausted, a new region may be allocated to store new messages. The new region may be allocated from any of the vDisks 116(1)-(2) and vDisks 126(1)-(2). Using virtual storage may allow another broker instance to take over handling of topic-partition messages with little or no interruption to the message service if one of the brokers 114(1)-(2) and 124(1)-(2) fails. Further, because the vDisks 116(1)-(2) and 126(1)-(2) are virtualized (e.g., rather than a physical storage disks), the size of each of the vDisks 116(1)-(2) and 126(1)-(2) can be dynamically adjusted according to data storage needs for each particular topic. That is, as the fixed sized regions carved out of the raw vDisks 116(1)-(2) and 126(1)-(2) may be exhausted, a new region from any of the raw vDisks 116(1)-(2) and 126(1)-(2) may be allocated to store the new messages.

The producers 118(1)-(2) and 128(1) may register with the respective master message service instance to receive an identifier and then may connect with the respective broker 114(1)-(2) and 124(1)-(2) assigned to a particular topic-partition to publish messages. Messages published by the producers 118(1)-(2) or 128(1) may include the respective identifier. Within the computing node cluster 110, the distributed message service 112 and/or the brokers 114(1)-114(2) may manage and track the consumers 119(1)-(2). Within the computing node cluster 120, the distributed message service 122 and/or the brokers 124(1)-124(2) may manage and track the consumers 129(1)-(2). When one of the consumers 119(1)-(2) or the consumers 129(1)-(2) connects to the computing node cluster 110 or the computing node cluster 120, respectively, the consumer may provide a handle. In response to receipt of the handle, the distributed message service 112 and/or the brokers 114(1)-114(2) (or the distributed message service 122 and/or the brokers 124(1)-(2)) may begin providing messages to the consumer based on the state of the subscription.

In some examples, the producers 118(1)-(2) and 128(1) and/or the consumers 119(1)-(2) and 129(1)-(2) may use different API architectures. For examples, the topic “A” producer 118(1) may use a first API architecture types and the topic “A” consumer 119(1) may use a second API architecture type. The distributed message service 112, the distributed message service 122, and/or the brokers 114(1)-(2) and 124(1)-(2) may be configured to translate or convert messages from one API type to another API type for communication between different API architectures.

The logical association of the brokers 114(1) and 114(2) to topic-partitions and the use of the vDisks 116(1)-(2) may allow another broker instance to take over the single topic-partition in the event of a failure of the original broker. The logical association of the brokers 114(1) and 114(2) to topic-partitions and the use of the vDisks 116(1)-(2) may also allow a topic to be further divided into additional topic-partitions or two or more topic-partitions may be combined into a single topic-partition as activity associated with a respective topic increases or decreases, respectively.

In addition, the subscriptions may be replicated across clusters, such as to allow for geographic replication. For example, a subscription associated with topic “C” on the computing node cluster 110 may be replicated on the computing node cluster 120 That is, the corresponding distributed message service 122 and/or the broker 124(2) of the computing node cluster 120 may register as a consumer or subscriber of topic “C” with the distributed message service 112 and/or the broker 114(2), and in response, the distributed message service 112 and/or the broker 114(2) may share message information received from the producer 118(2) with the corresponding distributed message service 122 and/or the broker 124(2) as a consumer. In addition, the corresponding distributed message service 122 and/or the broker 124(2) of the computing node cluster 120 may register the distributed message service 112 and/or the broker 114(2) as a producer for topic “C”, and in response to receiving messages from the distributed message service 112 and/or the broker 114(2), may store the messages in the vDisk 126(2). Thus, the vDisk 116(2) hosted on the computing node cluster 110 may be replicated on the computing node cluster 120 as the vDisk 126(2).

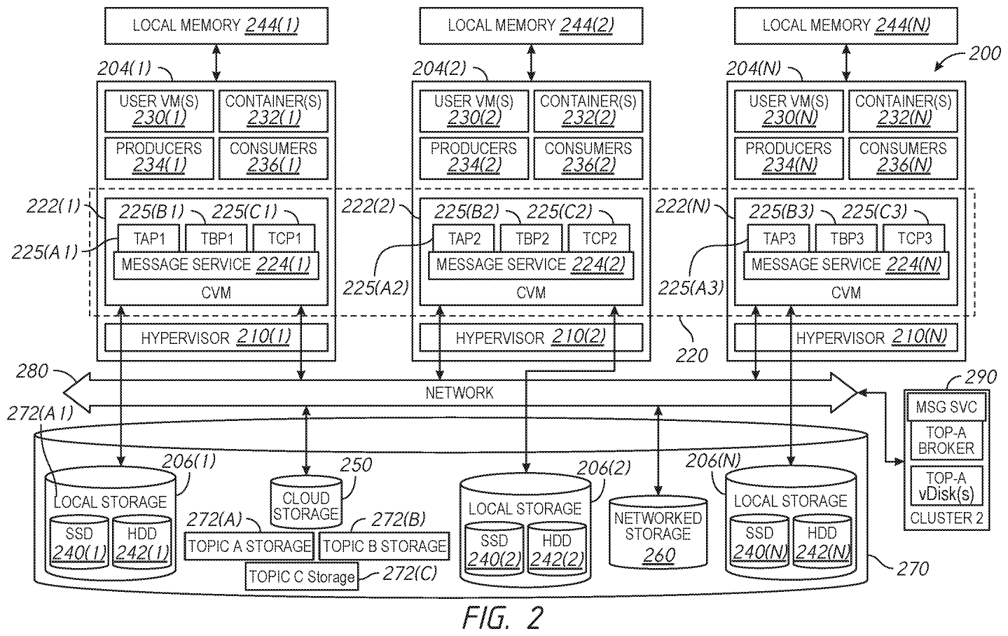

FIG. 2 is a block diagram of a distributed computing system 200, in accordance with an embodiment of the present disclosure. The distributed computing system 200 generally includes computing nodes (e.g., host machines, servers, computers, nodes, etc.) 204(1)-(N) and storage 270 connected to a network 280. While FIG. 2 depicts three computing nodes, the distributed computing system 200 may include two or more than three computing nodes without departing from the scope of the disclosure. The network 280 may be any type of network capable of routing data transmissions from one network device (e.g., computing nodes 204(1)-(N) and the storage 270) to another. For example, the network 280 may be a local area network (LAN), wide area network (WAN), intranet, Internet, or any combination thereof. The network CVM 322 may be a wired network, a wireless network, or a combination thereof. The computing node cluster 110 and/or the computing node cluster 120 of FIG. 1 may be configured to implement the distributed computing system 200, in some examples.

The storage 270 may include respective local storage 206(1)-(N), cloud storage 250, and networked storage 260. Each of the respective local storage 206(1)-(N) may include one or more solid state drive (SSD) devices 240(1)-(N) and one or more hard disk drives (HDD)) devices 242(1)-(N). Each of the respective local storage 206(1)-(N) may be directly coupled to, included in, and/or accessible by a respective one of the computing nodes 204(1)-(N) without communicating via the network 280. The cloud storage 250 may include one or more storage servers that may be stored remotely to the computing nodes 204(1)-(N) and may be accessed via the network 280. The cloud storage 250 may generally include any type of storage device, such as HDDs, SSDs, optical drives, etc. The networked storage (or network-accessed storage) 260 may include one or more storage devices coupled to and accessed via the network 280. The networked storage 260 may generally include any type of storage device, such as HDDs, SSDs, optical drives, etc. In various embodiments, the networked storage 260 may be a storage area network (SAN).

Each of the computing nodes 204(1)-(N) may include a computing device configured to host a respective hypervisor 210(1)-(N), a respective controller virtual machine (CVM) 222(1)-(N), respective user (or guest) virtual machines (VMs) 230(1)-(N), and respective containers 232(1)-(N). For example, each of the computing nodes 204(1)-(N) may be or include a server computer, a laptop computer, a desktop computer, a tablet computer, a smart phone, any other type of computing device, or any combination thereof. Each of the computing nodes 204(1)-(N) may include one or more physical computing components, such as one or more processor units, respective local memory 244(1)-(N) (e.g., cache memory, dynamic random-access memory (DRAM), non-volatile memory (e.g., flash memory), or combinations thereof), the respective local storage 206(1)-(N), ports (not shown) to connect to peripheral input/output (I/O) devices (e.g., touchscreens, displays, speakers, keyboards, mice, cameras, microphones, environmental sensors, etc.).

Each of the user VMs 230(1)-(N) hosted on the respective computing node includes at least one application and everything the user VM needs to execute (e.g., run) the at least one application (e.g., system binaries, libraries, etc.). Each of the user VMs 230(1)-(N) may generally be configured to execute any type and/or number of applications, such as those requested, specified, or desired by a user. Each of the user VMs 230(1)-(N) further includes a respective virtualized hardware stack (e.g., virtualized network adaptors, virtual local storage, virtual memory, processor units, etc.). To manage the respective virtualized hardware stack, each of the user VMs 230(1)-(N) is further configured to host a respective operating system (e.g., Windows®, Linux®, etc.). The respective virtualized hardware stack configured for each of the user VMs 230(1)-(N) may be defined based on available physical resources (e.g., processor units, the local memory 244(1)-(N), the local storage 206(1)-(N), etc.). That is, physical resources associated with a computing node may be divided between (e.g., shared among) components hosted on the computing node (e.g., the hypervisor 210(1)-(N), the CVM 222(1)-(N), other user VMs 230(I)-(N), the containers 232(1)-(N), etc.), and the respective virtualized hardware stack configured for each of the user VMs 230(1)-(N) may reflect the physical resources being allocated to the user VM. Thus, the user VMs 230(1)-(N) may isolate an execution environment my packaging both the user space (e.g., application(s), system binaries and libraries, etc.) and the kernel and/or hardware (e.g., managed by an operating system). While FIG. 2 depicts the computing nodes 204(1)-(N) each having multiple user VMs 230(1)-(N), a given computing node may host no user VMs or may host any number of user VMs.

Rather than providing hardware virtualization like the user VMs 230(1)-(N), the respective containers 232(1)-(N) may each provide operating system level virtualization. Thus, each of the respective containers 232(1)-(N) is configured to isolate the user space execution environment (e.g., at least one application and everything the container needs to execute (e.g., run) the at least one application (e.g., system binaries, libraries, etc.)) without requiring an operating system to manage hardware. Individual ones of the containers 232(1)-(N) may generally be provided to execute any type and/or number of applications, such as those requested, specified, or desired by a user. Two or more of the respective containers 232(1)-(N) may run on a shared operating system, such as an operating system of any of the hypervisor 210(1)-(N), the CVM 222(1)-(N), or other user VMs 230(1)-(N). In some examples, an interface engine may be installed to communicate between a container and an underlying operating system. While FIG. 2 depicts the computing nodes 204(1)-(N) each having multiple containers 232(1)-(N), a given computing node may host no containers or may host any number of containers.

Each of the hypervisors 210(1)-(N) may include any type of hypervisor. For example, each of the hypervisors 210(1)-(N) may include an ESX, an ESX(i), a Hyper-V, a KVM, or any other type of hypervisor. Each of the hypervisors 210(1)-(N) may manage the allocation of physical resources (e.g., physical processor units, volatile memory, the storage 270) to respective hosted components (e.g., CVMs 222(1)-(N), respective user VMs 230(1)-(N), respective containers 232(1)-(N)) and performs various VM and/or container related operations, such as creating new VMs and/or containers, cloning existing VMs and/or containers, etc. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API. Collectively, the hypervisors 210(1)-(N) may all include a common hypervisor type, may all include different hypervisor types, or may include any combination of common and different hypervisor types.

The CVMs 222(1)-(N) may provide services for the respective hypervisors 210(1)-(N), the respective user VMs 230(1)-(N), and/or the respective containers 232(1)-(N) hosted on a respective computing node of the computing nodes 204(1)-(N). For example, each of the CVMs 222(1)-(N) may execute a variety of software and/or may serve the I/O operations for the respective hypervisor 210(1)-(N), the respective user VMs 230(1)-(N), and/or the respective containers 232(1)-(N) hosted on the respective computing node 204(1)-(N). The CVMs 222(1)-(N) may communicate with one another via the network 280. By linking the CVMs 222(1)-(N) together via the network 280, a distributed network (e.g., cluster, system, etc.) of the computing nodes 204(1)-(N) may be formed. In an example, the CVMs 222(1)-(N) linked together via the network 280 may form a distributed computing environment (e.g., a distributed virtualized file server) 220 configured to manage and virtualize the storage 270. In some examples, a SCSI controller, which may manage the SSD devices 240(1)-(N) and/or the HDD devices 242(1)-(N) described herein, may be directly passed to the respective CVMs 222(1)-(N), such as by leveraging a VM-Direct Path, In the case of Hyper-V, the SSD devices 240(1)-(N) and/or the HDD devices 242(1)-(N) may be passed through to the respective CVMs 222(1)-(N).

The CVMs 222(1)-(N) may coordinate execution of respective services over the network 280, and the services running on the CVMs 222(1)-(N) may utilize the local memory 244(1)-(N) to support operations. The local memory 244(1)-(N) may be shared by components hosted on the respective computing node 204(1)-(N), and use of the respective local memory 244(1)-(N) may be controlled by the respective hypervisor 210(1)-(N). Moreover, multiple instances of the same service may be running throughout the distributed system 200. That is, the same services stack may be operating on more than one of the CVMs 222(1)-(N). For example, a first instance of a service may be running on the CVM 222(1), a second instance of the service may be running on the CVM 222(2), etc.

In some examples, the CVMs 222(1)-(N) may be configured to collectively manage a distributed message service, with each of the CVMs 222(1)-(N) hosting a respective message service instance 224(1)-(N) on an associated operating system to form the distributed message service. In some examples, one of the message service instances 224(1)-(N) may be designated as a master message service instance configured to coordinate collective operation of the message service instances 224(1)-(N). The message service instances 224(1)-(N) may be configured to facilitate exchange of respective information between producers (e.g., publishers, etc.) 234(1)-(N) and consumers (e.g., subscribers, etc.) 236(1)-(N). The message service instances 224(1)-(N) may be configured to interface with multiple messaging queue application programming interfaces (APIs), as well as translate messages across different messaging queue API architectures. The producers 234(1)-(N) may each include a virtual machine, a container, any type of computing device, an application, an input/output device, etc., or any combination thereof. The consumers 236(1)-(N) may each include a virtual machine, a container, any type of computing device, an application, an input/output device, etc., or any combination thereof.

The message service instances 224(1)-(N) may be configured in instantiate one or more message brokers, such as topic “A” brokers 225(A1)-(A3), topic “B” brokers 225(B1)-(B3), and topic “C” brokers 225(C1)-(C3). The lifecycle of the topic “A” brokers 225(A1)-(A3), the topic “B” brokers 225(B1)-(B3), and the topic “C” brokers 225(C1)-(C3) may be managed using containerized architecture. Each of the topic “A” brokers 225(A1)-(A3), the topic “B” brokers 225(B1)-(B3), and the topic “C” brokers 225(C1)-(C3) may register with a master message service instance of the message service instances 224(1)-(N), including providing a list of topics of interest. The master message service instance may logically allocate topics and partitions to each of the individual topic “A” brokers 225(A1)-(A3), topic “B” brokers 225(B1)-(B3), and topic “C” brokers 225(C1)-(C3) based on load balancing considerations and changes in topics and partitions. For example, the master message service may logically allocate topic “A” to the topic “A” brokers 5(A1)-(A3), with each of the topic “A” brokers 225(A1)-(A3) assigned a respective partition P1-P3. The master message service may logically allocate topic “B” to the topic “B” brokers 225(B1)-(B3), with each of the topic “B” brokers 225(B1)-(B3) allocated a respective partition P1-P3, The master message service may logically allocate topic “C” to the topic “C” brokers 225(C1)-(C3), with each of the topic “C” brokers 5(C1)-(C3) allocated a respective partition P1-P3.

as the fixed sized regions carved out of the raw vDisks 116(1)-(2) and 126(1)-(2) may be exhausted, a new region from any of the raw vDisks 116(1)-(2) and 126(1)-(2) may be allocated to store the new messages.

The master message service instance may also cause fixed sized regions carved out of one or more vDisk(s) (topic “A” storage) 272(A) to be allocated for topic “A”, fixed sized regions carved out of one or more vDisk(s) (topic “B” storage) 272(B) to be allocated for topic “B”, and fixed sized regions carved out of one or more vDisk(s) (topic “C” storage) 272(C) to be allocated for topic “C”. Because each of the topics “A”, “B”, and “C” may be allocated to the respective carved out regions of raw vDisks to form respective storage 272(A)-(C), the size of each of the respective storage 272(A)-(C) can be dynamically adjusted according to data storage needs for each particular topic, with new communications/messages appended to the respective carved out regions of raw vDisks. Thus, when a topic “A”, partition 1 producer of the producers 234(1)-(N) sends a message, the topic “A”, partition 1 broker 225(A1) appends the message to the region stored at the topic “A”, partition 1-3 vDisk 272(A).The logical association of topic “A” brokers 225(A1)-(A3) , the topic “B” brokers 225(B1)-(B3), and the topic “C” brokers 225(C1)-(C3) to topic-partitions and the use of the vDisks 272(A)-(C) for region message storage may allow another broker instance to take over the single topic-partition in the event of a failure of the original broker.

It is appreciated that more or fewer than three topics may be managed by the message service instances 224(1)-(N) and/or each topic may be included one, two, or more than three partitions without departing from the scope of the disclosure. The vDisks 272(A)-(C) may be accessible across the distributed computing system 200 to manage individual message topic-partitions.

One or more of the producers 234(1)-(N) may register with the master message service instance to receive an identifier and then may connect with the respective broker of the topic “A” brokers 225(A1)-(A3), the topic “B” brokers 225(B1)-(B3), and the topic “C” brokers 225(C1)-(C3) assigned to a particular topic-partition to publish messages. Any other master message service instance of another computing node may be able to take over in the event of failure of the original master message service instance. Messages published by the producers 234(1)-(N) may include the respective identifier.

The message service instances 224(1)-(N), the master message service instance, and/or the topic “A” brokers 225(A1)-(A3), the topic “B” brokers 225(B1)-(B3), and the topic “C” brokers 225(CI)-(C3) may manage and track the consumers 236(1)-(N). When one of the consumers 236(1)-(N) connects to the distributed computing system 200, the consumer may provide a handle. In response to receipt of the handle, the message service instances 224(1)-(N), the master message service instance, and/or the topic “A” brokers 225(A1)-(A3), the topic “B” brokers 225(B1)-(B3), and the topic “C” brokers 225(C1)-(C3) may begin providing messages to the consumer based on the state of the subscription. Each topic-partition managed by the topic “A” brokers 225(A1)-(A3), the topic “B” brokers 225(B1)-(B3), and the topic “C” brokers 225(C1)-(C3) may include more than a single producer and/or consumer. In some examples, either the message service instances 224(1)-(N), and/or the topic “A” brokers 225(A1)-(A3), the topic “B” brokers 225(B1)-(B3), and the topic “C” brokers 225(C1)-(C3) may manage a subscription list associated with each respective topic-partition.

In some examples, the producers 234(1)-(N) and/or the consumers 236(1)-(N) and may use different API architectures. :For examples, the topic “A” producer of the producers 234(1)-(N) may use a first API architecture types and the topic “A” consumer of the consumers 236(1)-(N) may use a second API architecture type. The message service instances 224(1)-(N), and/or the topic “A” brokers 225(A1)-(A3), the topic “B” brokers 225(B1)-(B3), and the topic “C” brokers 225(C1)-(C3) may be configured to translate or convert messages from one API type to another API type for communication between different API architectures.

The subscriptions may be replicated across clusters to allow for geographic replication. For example, a subscription associated with topic “A” on the distributed computing system 200 may be replicated on the second computing node cluster 290. That is, the distributed message service and/or a topic “A” broker hosted on the second computing node cluster 290 may register as a consumer or subscriber of topic “A” with the message service instances 224(1)-(N) and/or one of more of the topic “A” brokers 225(A1)-(A3), and in response, the message service instances 224(1)-(N) and/or one of more of the topic “A” brokers 225(A1)-(A3) may share message information received from topic “A” producers of the producers 234(1)-(N) with the distributed message service and/or a topic “A” broker hosted on the second computing node cluster 290 as a consumer. In addition, the distributed message service and/or a topic “A” broker hosted on the second computing node cluster 290 may register the message service instances 224(1)-(N) and/or one of more of the topic “A” brokers 225(A1)-(A3) as a producer for topic “A”, and in response to receiving messages from the message service instances 224(1)-(N) and/or one of more of the topic “A” brokers 225(A1)-(A3), may store the messages in a corresponding topic “A” vDisk. Thus, the topic “A” P1-P3 vDisk 272(A) hosted on the distributed computing system 200 may be replicated on the computing node cluster 290 as the topic “A” vDisk.

Generally, the CVMs 222(1)-(N) may be configured to control and manage any type of storage device of the storage 270. The CVMs 222(1)-(N) may implement storage controller logic and may virtualize all storage hardware of the storage 270 as one global resource pool to provide reliability, availability, and performance. IP-based requests may be generally used (e.g., by the user VMs 230(1)-(N) and/or the containers 232(1)-(N)) to send I/O requests to the CVMs 222(1)-(N). For example, the user VMs 230(1) and/or the containers 232(1) may send storage requests to the CVM 222(1) using an IP request, the user VMs 230(2) and/or the containers 232(2) may send storage requests to the CVM 222(2) using an IP request, etc. The CVMs 222(1)-(N) may directly implement storage and I/O optimizations within the direct data access path.

Note that the CVMs 222(1)-(N) provided as virtual machines utilizing the hypervisors 210(1)-(N). Since the CVMs 222(1)-(N) run “above” the hypervisors 210(1)-(N), some of the examples described herein may be implemented within any virtual machine architecture, since the CVMs 222(1)-(N) may be used in conjunction with generally any type of hypervisor from any virtualization vendor.

Virtual disks (vDisks), including the topic “A”, partition 1-3 vDisk 272(A), the topic “B”, partition 1-3 vDisk 272(B), and the topic “C”, partition 1-3 vDisk 272(C), may be structured from the storage devices in the storage 270. A vDisk generally refers to the storage abstraction that may be exposed by the CVMs 222(1)-(N) to be used by the user VMs 230(1)-(N) and/or the containers 232(1)-(N). Generally, the distributed computing system 200 may utilize an IP-based protocol, such as an Internet small computer system interface(iSCSI) or a network file system interface (NFS), to communicate between the user VMs 230(1)-(N), the containers 232(1)-(N), the CVMs 222(1)-(N), and/or the hypervisors 210(1)-(N). Thus, in some examples, the vDisk may be exposed via an iSCSI or a NFS interface, and may be mounted as a virtual disk on the user VMs 230(1)-(N) and/or operating systems supporting the containers 232(1)-(N). iSCSI may generally refer to an IP-based storage networking standard for linking data storage facilities together. By carrying SCSI commands over IP networks, iSCSI can be used to facilitate data transfers over intranets and to manage storage over any suitable type of network or the Internet. The iSCSI protocol may allow iSCSI initiators to send SCSI commands to iSCSI targets at remote locations over a network. NFS may refer to an IP-based file access standard in which NFS clients send file-based requests to NFS servers via a proxy folder (directory) called “mount point”.

During operation, the user VMs 230(1)-(N) and/or operating systems supporting the containers 232(1)-(N) may provide storage input/output (I/O) requests to the CVMs 222(1)-(N) and/or the hypervisors 210(1)-(N) via iSCSI and/or NFS requests. Each of the storage I/O requests may designate an IP address for a CVM of the CVMs 222(1)-(N) from which the respective user VM desires I/O services. The storage I/O requests may be provided from the user VMs 230(1)-(N) to a virtual switch within a hypervisor of the hypervisors 210(1)-(N) to be routed to the correct destination. For examples, the user 230(1) may provide a storage request to the hypervisor 210(1). The storage I/O request may request I/O services from a CVM of the CVMs 222(1)-(N). If the storage I/O request is intended to be handled by a respective CVM of the CVMs 222(1)-(N) hosted on a same respective computing node of the computing nodes 204(1)-(N) as the requesting user VM (e.g., CVM 222(1) and the user VM 230(1) are hosted on the same computing node 204(1)), then the storage I/O request may be internally routed within the respective computing node of the computing node of the computing nodes 204(1)-(N). In some examples, the storage I/O request may be directed to respective CVM of the CVMs 222(1)-(N) on another computing node of the computing nodes 204(1)-(N) as the requesting user VIVI (e.g., CVM 222(1) is hosted on the computing node 204(1) and the user VM 230(2) is hosted on the computing node 204(2)). Accordingly, a respective hypervisor of the hypervisors 210(1)-(N) may provide the storage request to a physical switch to be sent over the network 280 to another computing node of the computing nodes 204(1)-(N) hosting the requested CVM of the CVMs 222(1)-(N),

The CVMs 222(1)-(N) may collectively manage the storage I/O requests between the user VMs 230(1)-(N) and/or the containers 232(1)-(N) of the distributed computing system and a storage pool that includes the storage 270. That is, the CVMs 222(1)-(N) may virtualize I/O access to hardware resources within the storage pool. In this manner, a separate and dedicated CVM of the CVMs 222(1)-(N) may be provided each of the computing nodes 204(1)-(N) the distributed computing system 200. When a new computing node is added to the distributed computing system 200, it may include a respective CVM to share in the overall workload of the distributed computing system 200 to handle storage tasks. Therefore, examples described herein may be advantageously scalable, and may provide advantages over approaches that have a limited number of controllers. Consequently, examples described herein may provide a massively-parallel storage architecture that scales as and when computing nodes are added to the system.

The distributed system 200 may include a distributed message service that includes a respective message service instance 224(1)-(N) hosted on each of the CVMs 222(1)-(N). In some examples, one of the message service instances 224(1)-(N) may be designated as a master message service instance configured to coordinate collective operation of the message service instances 224(1)-(N). The message service instances 224(1)-(N) may be configured to facilitate exchange of respective information between the producers 234(1)-(N) and the consumers 236(1)-(N). The message service instances 224(I)-(N) may be configured to interface with multiple messaging queue application programming interfaces (APIs), as well as translate messages across different messaging queue API architectures. The producers 234(1)-(N) may each include a virtual machine, a container, any type of computing device, an application, an input/output device, etc., or any combination thereof. The consumers 236(1)-(N) may each include a virtual machine, a container, any type of computing device, an application, an input/output device, etc., or any combination thereof. In some examples, one of the

The message service instances 224(1)-(N) may be configured in instantiate one or more message brokers, such as topic “A” brokers 225(A1)-(A3), topic “B” brokers 225(B1)-(B3), and topic “C” brokers 225(C1)-(C3), with the lifecycle of the topic “A” brokers 225(A1)-(A3), the topic “B” brokers 225(B1)-(B3), and the topic “C” brokers 225(C1)-(C3) managed using containerized architecture. Each of the topic “A” brokers 225(A1)-(A3), the topic “B” brokers 225(B1)-(B3), and the topic “C” brokers 5(C1)-(C3) may register with a master message service instance of the message service instances 224(1)-(N), including providing a list of topics of interest. The master message service instance may logically allocate topics and partitions to each of the individual topic “A” brokers 225(A1)-(A3), topic “B” brokers 225(B1)-(B3), and topic “C” brokers 225(C1)-(C3) based on load balancing considerations and changes in topics and partitions. The master message service instance may also cause a topic “A”, partition 1-3 vDisk 272(A) to be allocated for topic “A”, a topic “B”, partition 1-3 vDisk 272(B) to be allocated for topic “B”, and a topic “C”, partition 1-3 vDisk 272(C) to be allocated for topic “C”. It is appreciated that more or fewer than three topics may be managed by the message service instances 224(1)-(N) and/or each topic may be included one, two, or more than three partitions without departing from the scope of the disclosure. The vDisks 272(A)-(C) may be accessible across the distributed computing system 200 to manage individual message topic-partitions.

The master message service instance and/or a respective one the message service instances 224(1)-(N) may also cause a topic “A”, partition 1-3 vDisk 272(A) to be allocated for topic “A”, a topic “B”, partition 1-3 vDisk 272(B) to be allocated for topic “B”, and a topic “C”, partition 1-3 vDisk 272(C) to be allocated for topic “C”. The topic “A” brokers 225(A1)-(A3), the topic “B” brokers 225(B1)-(B3), and the topic “C” brokers 225(C1)-(C3) may store messages may at the respective fixed sized region on raw vDisks 272(A)-(C) with new communications/messages appended to the region. Thus, when a topic “A”, partition 1 producer of the producers 234(1)-(N) sends a message, the topic “A”, partition 1 broker 225(A1) appends the message to the region stored at the topic “A”, partition 1-3 vDisk 272(A), The logical association of the topic “A” brokers 225(A1)-(A3), the topic “B” brokers 225(B1)-(B3), and the topic “C” brokers 225(C1)-(C3) to topic-partitions and the use of the vDisks 272(A)-(C) may allow another broker instance to take over the single topic-partition in the event of a failure of the original broker. That is, when the space in the topic “A” storage vDisk 272(A) is exhausted, a new region may be allocated to the topic “A” storage vDisk 272(A) to store the new messages. The new region may or may not be allocated from a different vDisk than the previous vDisk.

One or more of the producers 234(1)-(N) may register with the master message service instance to receive an identifier and then may connect with the respective broker of the topic “A” brokers 225(A1)-(A3), the topic “B” brokers 225(B1)-(B3), and the topic “C” brokers 225(C1)-(C3) assigned to a particular topic-partition to publish messages. Messages published by the producers 234(1)-(N) may include the respective identifier. The message service instances 224(1)-(N), the master message service instance, and/or the topic “A” brokers 225(A1)-(A3), the topic “B” brokers 225(B1)-(B3), and the topic “C” brokers 225(C1)-(C3) may manage and track the consumers 236(1)-(N). When one of the consumers 236(1)-(N) connects to the distributed computing system 200, the consumer may provide a handle. In response to receipt of the handle, the message service instances 224(1)-(N), the master message service instance, and/or the topic “A” brokers 225(A1)-(A3), the topic “B” brokers 225(B1)-(B3), and the topic “C” brokers 225(C1)-(C3) may begin providing messages to the consumer based on the state of the subscription. Each topic-partition managed by the topic “A” brokers 225(A1)-(A3), the topic “B” brokers 225(B1)-(B3), and the topic “C” brokers 225(C1)-(C3) may include more than a single producer and/or consumer. In some examples, either the message service instances 224(1)-(N), and/or the topic “A” brokers 225(A1)-(A3), the topic “B” brokers 225(B1)-(B3), and the topic “C” brokers 225(C1)-(C3) may manage a respective subscription list associated with each respective topic-partition, including adding and removing respective consumers 236(1)-(N), such as in response to receipt of a request from a respective consumer of the consumers 236(1)-(N) to be added to a respective subscription list associated with a particular topic-partition.

In some examples, the message service instances 224(1)-(N), and/or the topic “A” brokers 225(A1)-(A3), the topic “B” brokers 225(B1)-(B3), and the topic “C” brokers 225(C1)-(C3) may be configured to translate or convert messages from one API type to another API type for communication between different API architectures to communicate messages between the producers 234(1)-(N) and the consumers 236(1)-(N) using different API architectures.

The subscriptions may be replicated across clusters to allow for geographic replication. For example, the distributed message service and/or a topic “A” broker hosted on the second computing node cluster 290 may register as a consumer or subscriber of topic “A” with the message service instances 224(1)-(N) and/or one of more of the topic “A” brokers 225(A1)-(A3), and in response, the message service instances 224(1)-(N) and/or one of more of the topic “A” brokers 225(A1)-(A3) may share message information received from topic “A” producers of the producers 234(1)-(N) with the distributed message service and/or a topic “A” broker hosted on the second computing node cluster 290 as a consumer. In addition, the distributed message service and/or a topic “A” broker hosted on the second computing node cluster 290 may register the message service instances 224(1)-(N) and/or one of more of the topic “A” brokers 225(A1)-(A3) as a producer for topic “A”, and in response to receiving messages from the message service instances 224(1)-(N) and/or one of more of the topic “A” brokers 225(A1)-(A3), may store the messages in a corresponding topic “A” vDisk. Thus, the topic “A” P1-P3 vDisk 272(A) hosted on the distributed computing system 200 may be replicated on the computing node cluster 290 as the topic “A” vDisk.

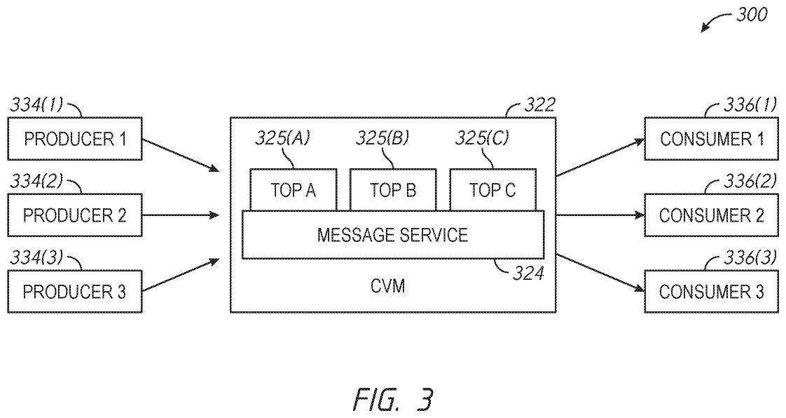

FIG. 3 is a block diagram of a distributed message service 300, in accordance with an embodiment of the present disclosure. The distributed message service 300 may include a CVM 322 configured to host a message service instance 324. The computing node cluster 110 and/or the computing node cluster 120 of FIG. 1, and/or any of the 222(1)-(N) of FIG. 2 may be configured to implement the CVM 32 and/or the message service instance 324 of FIG. 3.

The controller virtual machine (CVM) 322 may be hosted on a computing node and may be integrated with core CVMs hosted across other computing nodes of a computing node cluster. The CVM 322 may be configured to host the message service instance 324 to support an integrated message service to facilitate the exchange respective information between producers (e.g., publishers, etc.) 334(1)-(3) and consumers (e.g., subscribers, etc.) 336(1)-(3). The message service instance 324 may be configured to interface with multiple messaging queue application programming interfaces (APIs), as well as translate messages across different messaging queue API architectures. The producers 334(1)-(3) may each include a virtual machine, a container, any type of computing device, an application, an input/output device, etc., or any combination thereof. The consumers 336(1)-(3) may each include a virtual machine, a container, any type of computing device, an application, an input/output device, etc., or any combination thereof.

The message service instance 324 may instantiate and logically allocate brokers 325(A)-(C) to manage individual message topic-partitions. The lifecycle of the brokers 325(A)-(C) may be managed using containerized architecture. Each of the brokers 325(A)-(C) may register with the message service instance 324, including providing a list of topics of interest. The message service instance 324 may allocate topics and partitions to each of the individual brokers 325(A)-(C) based on load balancing considerations and changes in topics and partitions. The broker 325(A) be associated with topic “A”, the broker 325(B) may be associated with topic “B”, and the broker 325(C) may be associated with topic “C”. The broker 325(A) may be configured to manage messages received from any topic “A” producer of the producers 334(1)-(3), which may include storing the received messages at a carved out fixed sized region of a respective virtual disk and providing the messages to any topic “A” consumer of the consumers 336(1)-(N). Similarly, the broker 325(B) may be configured to manage messages received from any topic “B” producer of the producers 334(1)-(3), which may include storing the received messages at a carved out fixed sized region of a respective virtual disk and providing the messages to any topic “B” consumer of the consumers 336(1)-(N). The broker 325(C) may be configured to manage messages received from any topic “C” producer of the producers 334(1)-(3), which may include storing the received messages at a carved out fixed sized region of a respective virtual disk and providing the messages to any topic “C” consumer of the consumers 336(1)-(N). The brokers 325(A)-(C) storing new communications/messages in the region may include appending the new message/communication to the region. The logical association of the brokers 325(A)-(C) to topics to topic-partitions may allow another broker instance to take over the single topic-partition in the event of a failure of the original broker. In some examples, the brokers 325(A)-(C) may allocated both a topic and a partition, such that one topic is broken into partitions, with each partition managed by a different broker. While message service instance 324 is depicted as hosting three of the brokers 325(A)-(C), more or fewer brokers may be hosted by the message service instance 324 without departing from the scope of the disclosure. In addition, each topic may include fewer or more than three producers and/or consumers. In some examples, the message service instance 324 and/or the brokers 325(A)-(C) may manage a subscription list associated with each respective topic.

The producers 334(1)-(3) may register with the master message service instance to receive an identifier and then may connect with the respective broker 325(A)-(C) assigned to a particular topic-partition to publish messages. Messages published by the producers 334(1)-(3) may include the respective identifier. The message service instance 324 and/or the brokers 325(A)-(C) may manage and track the consumers 336(1)-(3). When one of the consumers 336(1)-(3) connects to the message service instance 324, the consumer may provide a handle. In response to receipt of the handle, the message service instance 324 and/or the brokers 325(A)-(C) may begin providing messages to the consumer based on the state of the subscription.

In some examples, the message service instance 324, and/or the brokers 325(A)-(C) may be configured to translate or convert messages from one API type to another API type for communication between different API architectures to communicate messages between the producers 334(1)-(3) and the consumers 336(1)-(3) using different API architectures.

In operation, the message service instance 324 may be configured to facilitate communication of messages from the respective producers 334(1)-(3) to the respective consumers 336(1)-(3) for each topic-partition. The message service instance 324 may instantiate and logically allocate the brokers 325(A)-(C) to topic-partitions.

Thus, the broker 325(A) may be logically associated with topic “A”, the broker 325(B) may be logically associated with topic “B”, and the broker 325(C) may be logically associated with topic “C”. Each of the brokers 325(A)-(C) may be configured to manage messages received from respective topic-partition producers of the producers 334(1)-(3), which may include storing the received messages in a virtual disk and providing the messages to the respective topic-partition consumers of the consumers 236(1)-(3). In some examples management of messages receive may further include translation of messages from one API architecture type to another API architecture type to communication between the producers 334(1)-(3) and consumers 336(1)-(3) having different API architecture types.

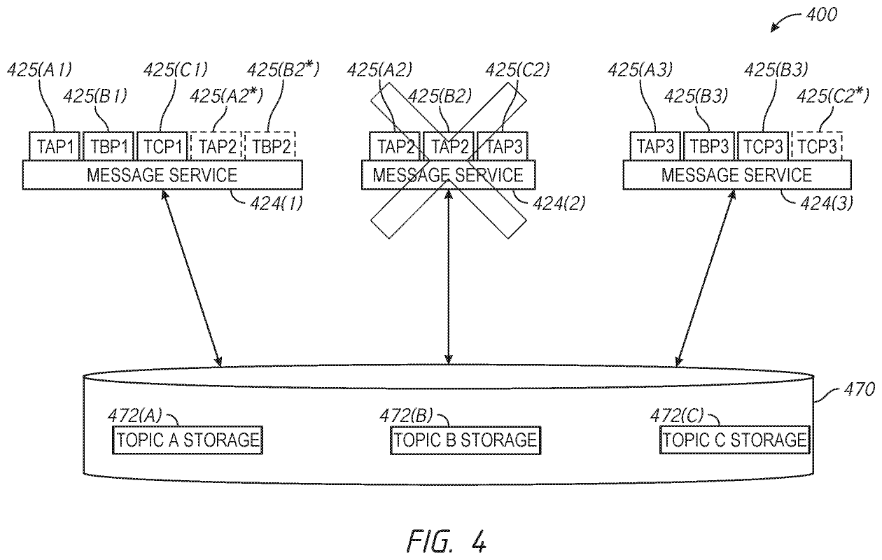

FIG. 4 is a block diagram of a distributed message service 400 with a failed message service instance, in accordance with an embodiment of the present disclosure. The distributed message service 400 may include message service instances 424(1)-(3). The distributed message service 112 and/or the distributed message service 122 of FIG. 1, any of the 224(1)-(N) of FIG. 2, and/or the message service instance 324 of FIG. 3 may be configured to implement any of the 424(1)-(3) of FIG. 4.

The message service instances 424(1)-(3) may be configured to facilitate exchange of respective information between producers and consumers. The message service instances 424(1)-(3) may be configured in instantiate one or more message brokers, such as topic “A” brokers 425(A1)-(A3), topic “B” brokers 425(B1)-(B3), and topic “C” brokers 425(C1)-(C3), with the lifecycle of the topic “A” brokers 425(A1)-(A3), the topic “B” brokers 425(B1)-(B3), and the topic “C” brokers 425(C1)-(C3) managed using containerized architecture. Each of the topic “A” brokers 425(A1)-(A3), the topic “B” brokers 425(B1)-(B3), and the topic “C” brokers 425(C1)-(C3) may register with a master message service instance of the message service instances 424(1)-(3), including providing a list of topics of interest. Within storage 470, the message service instances 424(1)-(3) may logically allocate topics and partitions to each of the individual topic “A” brokers 425(A1)-(A3), topic “B” brokers 425(B1)-(B3), and topic “C” brokers 425(C1)-(C3) based on load balancing considerations and changes in topics and partitions. The master message service instance may also cause a topic “A”, partition 1-3 vDisk 272(A) to be allocated for topic “A”, a topic “B”, partition 1-3 vDisk 272(B) to be allocated for topic “B”, and a topic “C”, partition 1-3 vDisk 272(C) to be allocated for topic “C”.

The topic “A” brokers 425(A1)-(A3), the topic “B” brokers 425(B1)-(B3), and the topic “C” brokers 425(C1)-(C3) may store messages may at the fixed sized region carved out of the respective raw vDisks (topics “A”, “B”, and “C” storage) 472(A)-(C), with new communications/messages appended. Thus, when a topic “A”, partition 1 producer sends a message, the topic “A”, partition 1 broker 425(A1) appends the message to the topic “A” storage 472(A). In the case where the region may be exhausted, a new region from a same or different vDisk may be allocated to the store the new messages in the respective one of the topics “A”, “B”, or “C” storage 472(A)-(C).

The logical association of the topic “A” brokers 425(A1)-(A3), the topic “B” brokers 425(B1)-(B3), and the topic “C” brokers 425(C1)-(C3) to topic-partitions and the use of the topics “A”, “B”, or “C” storage for message storage may allow failover to another broker instance to take over the single topic-partition in the event of a failure of the original broker. For example, as shown in FIG. 4, when the message service instance 424(2) fails, each of the topic “A”, partition 2. broker 425(A2) topic “B”, partition 2 broker 425(B2), and topic “C”, partition 2 broker 425(C2) may also fail. In response, the message service instance 424(1) may instantiate a new topic “A”, partition 2 broker 425(A2*) and a new topic “13”, partition 2 broker 425(B2*) to manage topic “A”, partition 2 messages and topic “B”, partition 2 messages, respectively. Each of the new topic “A”, partition 2 broker 425(A2*) and the new topic “B”, partition 2 broker 425(B2*) may resume appending new messages to the log files stored at the vDisk 472(A) and (B), respectively, at a place where the topic “A”, partition 2 broker 425(A2) and the topic “B”, partition 2 broker 425(B2) left off.

Similarly, in response to failure of the topic “C”, partition 2 broker 425(C2) failing, the message service instance 424(3) may instantiate a new topic “C”, partition 2 broker 425(C2*) to manage topic “C”, partition 2 messages. The new topic “C”, partition 2 broker 425(C2*) may resume appending new messages to the regions stored at the topic “C” storage 472(C) at a place where the topic “C”, partition 2 broker 425(C2) left off.

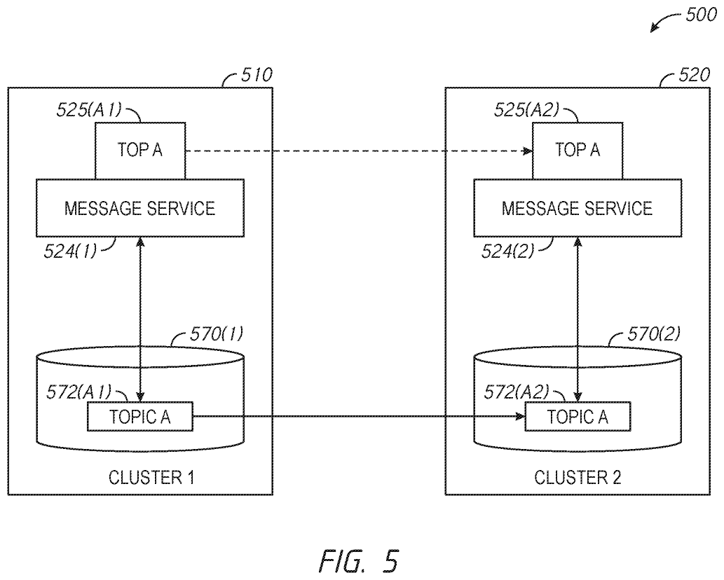

FIG. 5 is a system diagram of a cross-cluster message service replication system 500, in accordance with an embodiment of the present disclosure. The system may include a computing node cluster 510 and a computing node cluster 520. The computing node cluster 110 and/or the computing node cluster 120 of FIG. 1, and/or any of the distributed computing system 200 and/or the second computing node cluster 290 of FIG. 2, the distributed message service 300 of FIG. 3, and/or the distributed message service 400 of FIG. 4 may be configured to implement some or all of the computing node cluster 510 and/or the computing node cluster 520.

The computing node cluster 510 may include a distributed message service 524(1) that is integrated with core controller virtual machines hosted across computing nodes (e.g., host machines, servers, etc.) of the computing node cluster 510 to support an integrated message service across the computing node cluster 510 to facilitate an exchange of respective information between producers and consumers. The distributed message service 524(1) may instantiate and logically allocate broker 525(1) to manage individual message topic-partitions. The lifecycle of the broker 525(1) may be managed using containerized architecture. The broker 525(1) may register with a master message service instance of the distributed message service 524(1), including providing a list of topics of interest. The master message service instance may allocate topics and partitions to each of the broker 525(1) based on load balancing considerations and changes in topics and partitions. The broker 525(1) may be associated with topic “A” to manage messages received from topic “A” producers, which may include storing the received messages in a carved out fixed sized region of one or more vDisks (topic “A” storage) 572(A1) of the storage 570(1) and providing the messages to topic “A” consumers. The topic “A” storage 572(A1) may be accessible across the computing node cluster 510, to serve as storage for received messages for topic “A”.

The computing node cluster 520 may include a distributed message service 524(2) that is integrated with core controller virtual machines hosted across computing nodes (e.g., host machines, servers, etc.) of the computing node cluster 520 to support an integrated message service across the computing node cluster 520 to facilitate an exchange of respective information between producers and consumers. The distributed message service 524(2) may instantiate and logically allocate broker 525(2) to manage individual message topic-partitions. The lifecycle of the broker 525(2) may be managed using containerized architecture. The broker 525(2) may register with a master message service instance of the distributed message service 524(2), including providing a list of topics of interest. The master message service instance may allocate topics and partitions to each of the broker 525(2) based on load balancing considerations and changes in topics and partitions. The broker 525(2) may be associated with topic “A” to manage messages received from topic “A” producers, which may include storing the received messages in a carved out fixed sized region of one or more vDisks (topic “A” storage) 572(A2) of the storage 570(2)and providing the messages to topic “A” consumers. The topic “A” storage 572(A2) may be accessible across the computing node cluster 520, to serve as storage for received messages for topic “A”.

However, in the example depicted in FIG. 5, the producers for topic “A” may be located at the computing node cluster 510. Thus, in order to maintain continuity for topic “A” messaging at the computing node cluster 520, the broker 525(2) may subscribe to the distributed message service 524(1) as a consumer of the topic “A” messages, and the distributed message service 524(2) may register the broker 525(1) as a topic “A” producer. Accordingly, when the broker 525(1) receives a message from a topic “A” producer, the broker 525(1) appends the message to the topic “A” storage 572(A1) and provides that message to the topic “A” consumers, including the broker 525(2). In response to receipt of the topic “A” message from the broker 525(1), the broker 525(2) appends the message to the topic “A” storage 572(A2) and provides that message to the topic “A” consumers subscribed to topic “A” at the distributed message service 524(2). Thus, as shown in FIG. 5, the subscriptions may be replicated across clusters to allow for geographic replication.

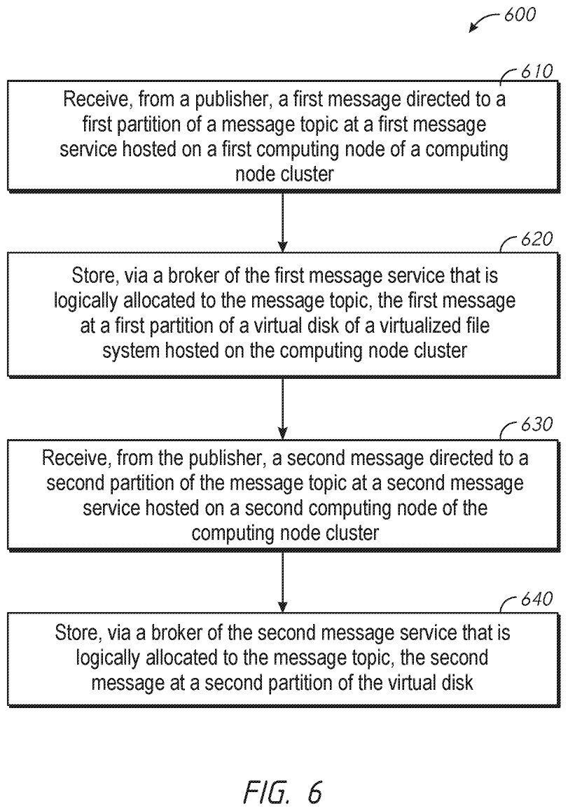

FIG. 6 is a flow diagram illustrating a method 600 for a distributed message service, in accordance with an embodiment of the present disclosure. The method 600 may be performed using part or all of the computing node cluster 110 and/or the computing node cluster 120 of FIG. 1, the distributed computing system 200 of FIG. 2, the distributed message service 300 of FIG. 3, the distributed message service 400 of FIG. 4, and/or the cross-cluster message service replication system 500 of FIG. 5.

The method 600 may include receiving, from a publisher, a first message directed to a first partition of a message topic at a first message service hosted on a first computing node of a computing node cluster, at 610. The computing node cluster may include any of the computing node cluster 110 or the computing node cluster 120 of FIG. 1, the distributed computing system 200 and/or the second computing node cluster 290 of FIG. 2, the computing node cluster 510 or the computing node cluster 520 of FIG. 5, or combinations thereof. The computing node may include any of the computing nodes 204(1)-(N) of FIG. 2. The publisher may include any of the producers 118(1)-(2) and/or 128(1) of FIG. 1, the producers 234(1)-(N) of FIG. 2, the producers 334(1)-(3) of FIG. 3, or combinations thereof. The first message service may include a message service instance of the distributed message service 112 and/or the distributed message service 122 of FIG. 1, any of the message service instances 224(1)-(N) of FIG. 2, the message service instance 324 of FIG. 3, any of the message service instances 424(1)-(3) of FIG. 4, a message service instance of the distributed message services 524(1)-(2) of FIG. 5, or any combination thereof.

The method 600 may further include storing, via a broker of the first message service that is logically allocated to the first partition of the message topic, the message at a first partition of a virtual disk of a virtualized file system hosted on the computing node cluster, at 620. The broker of the first message service may include any of the brokers 114(1)-(2) and/or 124(1)-(2) of FIG. 1, any of the topic “A” partition 1-3 brokers 225(A1)-(A3), topic “B” partition 1-3 brokers 225(B1)-(B3), and/or topic “C” partition 1-3 brokers 225(C1)-(C3) of FIG. 2, any of the brokers 325(A)-(C) of FIG. 3, any of the topic “A” partition 1-3 brokers 225(A1)-(A3), the topic “B” partition 1-3 brokers 225(B1)-(B3), the topic “C” partition 1-3 brokers 225(C1)-(C3), and/or the brokers 425(A2*), 425(B2*), or 425(C2*) of FIG. 4, the brokers 525(1)-(2) of FIG. 5, or combinations thereof. The virtual disk may include any of the vDisks 116(1)-(2) and/or the 126(1)-(2) of FIG. 1, any vDisk of the topic “A” storage 272(A), the topic “B” storage 272(B), or the topic “C” storage 272(C) of FIG. 2., the topics “A”, “B”, and/or “C” storage 472(A)-(C) of FIG. 4, any of the topic “A” storage 572(A1)-(A2) of FIG. 5, or combinations thereof. The virtualized file system may include the distributed computing environment 220 of FIG. 2. In some examples, the first message may be appended to a carved out fixed sized region maintained at the first partition of the virtual disk to store the first message. In some examples, the method 600 may further include converting the first message from a first application programming interface (API) type to a second API type prior to storing the first message at the first partition of the virtual disk.

In some examples, the method 600 may further include routing, via the broker of the first message service, the first message to a subscriber. The subscriber may include any of the consumers 119(1)-(2) and/or 129(1)-(2) of FIG. 1, the consumers 236(1)-(N) of FIG. 2, the consumers 336(1)-(3) of FIG. 3, or combinations thereof. In some examples, the method 600 may further include routing the first message to the subscriber in response to the subscriber being included in a subscriber list corresponding to the message topic. In some examples, the method 600 may further include adding the subscriber to the subscriber list in response to receipt of a. request from the subscriber. The subscriber list may be maintained by one or the first or second message service and/or the respective brokers. In some examples, the method 600 may further include increasing a size of the virtual disk in response to available storage being less than an available storage threshold.

The method 600 may further include receiving, from the publisher, a second message directed to a second partition of the message topic at a second message service hosted on a second computing node of the computing node cluster, at 630. The computing node may include any of the computing nodes 204(1)-(N) of FIG. 2. The second message service may include a message service instance of the distributed message service 112 and/or the distributed message service 122 of FIG. 1, any of the message service instances 224(1)-(N) of FIG. 2, the message service instance 324 of FIG. 3, any of the message service instances 424(1)-(3) of FIG. 4, a message service instance of the distributed message services 524(1)-(2) of FIG. 5, or any combination thereof.

The method 600 may further include storing, via a broker of the second message service that is logically allocated to the second partition of the message topic, the second message at a second partition of the virtual disk, at 640. The broker of the second message service may include any of the brokers 114(1)-(2) and/or 124(1)-(2) of FIG. 1, any of the topic “A” partition 1-3 brokers 225(A1)-(A3), topic “B” partition 1-3 brokers 225(B1)-(B3), and/or topic “C” partition 1-3 brokers 225(C1)-(C3) of FIG. 2, any of the brokers 325(A)-(C) of FIG. 3, any of the topic “A” partition 1-3 brokers 225(A1)-(A3), the topic “B” partition 1-3 brokers 225(B1)-(B3), the topic “C” partition 1-3 brokers 225(C1)-(C3), and/or the brokers 425(A2*), 425(B2*), or 425(C2*) of FIG. 4, the brokers 525(1)-(2) of FIG. 5, or combinations thereof. In some examples, the method 600 may further include routing, via the broker of the second message service, the second message to the subscriber. In some examples, the method 600 may further include routing the second message to the subscriber in response to the subscriber being included in the subscriber list corresponding to the message topic.

In some examples, the method 600 may include, in response to failure of the broker of the second message service, logically allocating the second partition of the message topic to a second broker of the first message service. In some examples, the method 600 may further include logically allocating a second broker of the first message service to a partition of a second topic in response to receiving a registration request from the second broker. In some examples, the method may further include managing a lifecycle of the broker and/or the second broker of the first message service and/or the broker of the second message service using a containerized architecture.

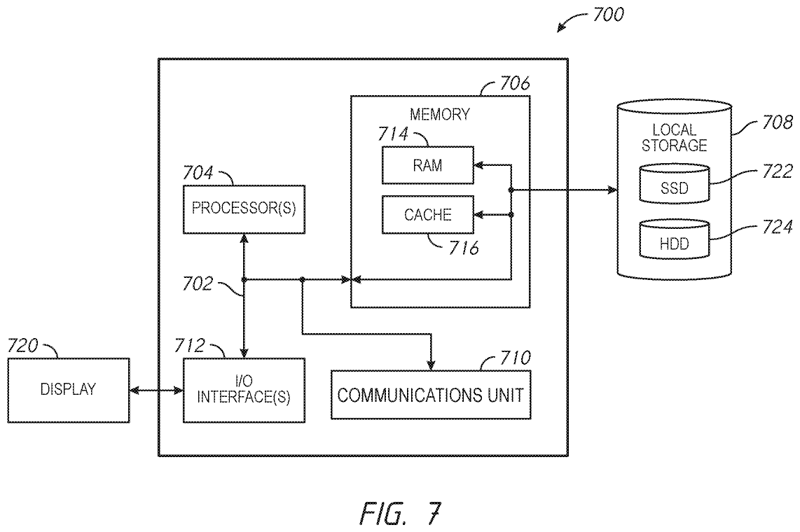

FIG. 7 depicts a block diagram of components of a computing node 700 in accordance with an embodiment of the present disclosure. It should be appreciated that FIG. 7 provides only an illustration of one implementation and does not imply any limitations with regard to the environments in which different embodiments may be implemented. Many modifications to the depicted environment may be made. The computing node 700 may implemented as any of a computing node of the computing node cluster 110 or the computing node cluster 120 of FIG. 1, any of the computing nodes 204(1)-(N) or a computing node of the second computing node cluster 290 of FIG. 2, a computing node of either of the computing node cluster 510 or the computing node cluster 520 of FIG. 5, or any combination thereof. The computing node 700 may be configured to host, at least in part, the distributed message service 300 of FIG. 3 and/or the distributed message service 400 of FIG. 4. The computing node 700 may be configured to implement the method 600 of FIG. 6 to host one or more brokers and/or messages services of a distributed message system.

The computing node 700 includes a communications fabric 702, which provides communications between one or more processor(s) 704, memory 706, local storage 708, communications unit 710, I/O interface(s) 712. The communications fabric 702 can be implemented with any architecture designed for passing data and/or control information between processors (such as microprocessors, communications and network processors, etc.), system memory, peripheral devices, and any other hardware components within a system. For example, the communications fabric 702 can be implemented with one or more buses.

The memory 706 and the local storage 708 are computer-readable storage media. In this embodiment, the memory 706 includes random access memory RAM 714 and cache 716. In general, the memory 706 can include any suitable volatile or non-volatile computer-readable storage media. The local storage 708 may be implemented as described above with respect to local storage 224 and/or local storage network 240 of FIGS. 2-4 in this embodiment, the local storage 708 includes an SSD 722 and an HDD 724, which may be implemented as described above with respect to any of SSD 240(1)-(N) and any of HDD 242(1)-(N), respectively.

Various computer instructions, programs, files, images, etc. may be stored in local storage 708 for execution by one or more of the respective processor(s) 704 via one or more memories of memory 706. In some examples, local storage 708 includes a magnetic HDD 724. Alternatively, or in addition to a magnetic hard disk drive, local storage 708 can include the SSD 722, a semiconductor storage device, a read-only memory (ROM), an erasable programmable read-only memory (EPROM), a flash memory, or any other computer-readable storage media that is capable of storing program instructions or digital information.

The media used by local storage 708 may also be removable. For example, a removable hard drive may be used for local storage 708. Other examples include optical and magnetic disks, thumb drives, and smart cards that are inserted into a drive for transfer onto another computer-readable storage medium that is also part of local storage 708.

Communications unit 710, in these examples, provides for communications with other data processing systems or devices. In these examples, communications unit 710 includes one or more network interface cards. Communications unit 710 may provide communications through the use of either or both physical and wireless communications links.

I/O interface(s) 712 allows for input and output of data with other devices that may be connected to computing node 700. For example, I/O interface(s) 712 may provide a connection to external device(s) 718 such as a keyboard, a keypad, a touch screen, and/or some other suitable input device. External device(s) 718 can also include portable computer-readable storage media. such as, for example, thumb drives, portable optical or magnetic disks, and memory cards. Software and data used to practice embodiments of the present disclosure can be stored on such portable computer-readable storage media and can be loaded onto local storage 708 via I/O interfaces) 712. I/O interface(s) 712 also connect to a display 720.

Display 720 provides a mechanism to display data to a user and may be, for example, a computer monitor.

Various features described herein may be implemented in hardware, software executed by a processor, firmware, or any combination thereof. If implemented in software (e.g., in the case of the methods described herein), the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

From the foregoing it will be appreciated that, although specific embodiments of the disclosure have been described herein for purposes of illustration, various modifications may be made without deviating from the spirit and scope of the disclosure, Accordingly, the disclosure is not limited except as by the appended claims.

1. At least one non-transitory computer-readable storage medium including instructions that when executed by a computing node of a computing node cluster, causes the computing node to:
receive, from a publisher, a first message directed to a first partition of a message topic at a first message service;
store, via a first broker of the message service that is logically allocated to the first partition of the message topic, the first message at a first partition of a virtual disk of a virtualized file system hosted on the computing node cluster;
receive, from the publisher, a second message directed to a second partition of the message topic at the message service;
store, via a second broker of the message service that is logically allocated to the second partition of the message topic, the second message at a second partition of the virtual disk; and
in response to failure of the first broker of the message service, instantiate a new first broker of the message service that is logically allocated to the first partition of the message topic.

2. (canceled)

3. The at least one non-transitory computer-readable storage medium of claim 1, further including instructions which cause the computing node to append the first message to the first partition of the virtual disk to store the first message.

4. The at least one non-transitory computer-readable storage medium of claim 1, further including instructions to route, via the first broker and the second broker, the first message and the second message, respectively, to a subscriber.

5. The at least one non-transitory computer-readable storage medium of claim 1 further including instructions to route the first message to a subscriber in response to the subscriber being included in a subscriber list corresponding to the message topic.

6. The at least one non-transitory computer-readable storage medium of claim 5, further including instructions to add the subscriber to the subscriber list in response to receipt of a request from the subscriber.

7. The at least one non-transitory computer-readable storage medium of claim 1, further including instructions to convert the first message from a first application programming interface (API) type to a second API type prior to storing the first message at the first partition of the virtual disk.

8. The at least one non-transitory computer-readable storage medium of claim 1, further including instructions to increase a size of the virtual disk in response to available storage being less than an available storage threshold.

9. The at least one non-transitory computer-readable storage medium of claim 1, further including instructions which cause the computing node to logically allocate a third broker of the message service to a partition of a second topic in response to receiving a registration request from the third broker.

10. The at least one non-transitory computer-readable storage medium of claim 1, further including instructions to manage a lifecycle of the first broker using a containerized architecture.

11. A computing node cluster, comprising one or more processors and memory configured to cause the computing node cluster to host:
a virtualized file system including a virtual disk configured to store messages for a message topic;
a broker logically allocated to the message topic, wherein the broker is configured to cause a message directed to the message topic provided from a publisher to be stored at the virtual disk, wherein the broker is further configured to route the message to a subscriber of the message topic that is registered with the broker; and
an operating system configured to manage the virtualized file system, the operating system including a message service configured to manage logical allocation of the broker and manage allocation of the virtual disk to the message topic, wherein, in response to failure of the broker, the operating system is configured to instantiate a new broker that is logically allocated to the message topic.

12. (canceled)

13. The computing node cluster of claim 10, wherein the new broker is configured to cause a second message directed to the message topic provided from the publisher to be stored at the virtual disk.

14. The computing node cluster of claim 11, wherein the broker is configured to append the message to the virtual disk.

15. The computing node cluster of claim 11, wherein the broker is configured to provide the message to a subscriber in response to the subscriber being included in a subscriber list corresponding to the message topic.

16. The computing node cluster of claim 15, wherein the message service is configured to add the subscriber to the subscriber list in response to receipt of a request from the subscriber.

17. The computing node cluster of claim 11, wherein the broker is configured to convert the message from a first application programming interface (API) type to a second API type prior to storing the message at the virtual disk.

18. The computing node cluster of claim 11, wherein the message service is configured to increase a size of the virtual disk in response to available storage being less than an available storage threshold.

19. The computing node cluster of claim 11, wherein the message service is configured to logically allocate the broker to a first partition of the message topic and a second broker to a second partition of the message topic in response to receiving a registration request from the second broker.

20. The computing node cluster of claim 11, wherein the message service is configured to instantiate the broker using a containerized architecture.

21. A method, comprising:
receiving, from a publisher, a first message directed to a first partition of a message topic at a first message service hosted on a first computing node of a computing node cluster;
storing, via a broker of the first message service that is logically allocated to the first partition of the message topic, the first message at a first partition of a virtual disk of a virtualized file system hosted on the computing node cluster;
receiving, from the publisher, a second message directed to a second partition of the message topic at a second message service hosted on a second computing node of the computing node cluster; and
storing, via a broker of the second message service that is logically allocated to the second partition of the message topic, the second message at a second partition of the virtual disk; and
in response to failure of the broker of the first message, instantiating a new broker of the first message service that is logically allocated to the first partition of the message topic.

22. (canceled)

23. The method of claim 21, further comprising routing, via the broker of the first message service and the broker of the second message service, the first message and the second message, respectively, to a subscriber in response to the subscriber being included in a subscriber list corresponding to the message topic.

24. The method of claim 21, further comprising converting the first message from a first application programming interface (API) type to a second API type prior to storing the first message at the first partition of the virtual disk.

25. The method of claim 21., further comprising managing a lifecycle of the broker of the first message service using a containerized architecture.

26. The method of claim 21, further including increasing a size of the virtual disk in response to available storage being less than an available storage threshold.

27. The at least one non-transitory computer-readable storage medium of claim 1, further including instructions to resume storage of subsequent messages directed to the first partition of the message topic to the first partition of the virtual disk where the first broker left off via the new first broker.

28. The method of claim 21, further comprising resuming storage of subsequent messages directed to the first partition of the message topic to the first partition of the virtual disk where the first broker left off via the new first broker.
